(19) United States
(12) Patent Application Publication
(10) Pub. No.: US 2008/0235241 A1
(43) Pub. Date: Sep. 25, 2008

(54) Print web portal

(76) Inventors: Tomoki Hattori, Duluth, GA (US); Kenneth Czajkowski, Fairfax, VA (US)

Correspondence Address: COOPER & DUNHAM, LLP, 1185 AVENUE OF THE AMERICAS, NEW YORK, NY, 10036, US

(21) Appl. No.: 11/728,149

(22) Filed: Mar. 23, 2007

(51) Int. Cl. G06F 17/30

(52) U.S. Cl. 707/10

(57) ABSTRACT

A web portal is provided for accessing information from a plurality of heterogeneous systems connected through a network, in connection with printing and other operations for forming images. The web portal includes means for registering dynamically a sequence of actions as a scenario, and applying the registered scenario of actions in one or more of the network distributed systems.

### TECHNICAL FIELD

This disclosure relates to printing and other image formation operations. In particular, the disclosure relates to a print web portal that enables access to such printing and other image formation operations, as well as other functionalities and information in connection therewith, as a web service.

### BACKGROUND

In the current information age, more and more information technology (IT) tools are available. The current trend is that users would like to use such IT tools and access information without being restricted to access from the user's desktop computer. For example, a user may wish to retrieve his/her e-mails while using an information appliance, a notebook computer, another information terminal, etc., away from the office and/or away from home.

The user may also wish to avail himself/herself to other IT tools that may have more complicated operations and involve complex software that cannot operate on an information appliance or another portable device, since such device lacks the storage and/or processing resources for executing the software natively. Accordingly, it is becoming increasingly prevalent for such software functionalities to be offered to users as web services which users can access through a web portal.

One of the functionalities that is now becoming available as a web service is printing and other image formation operations. While the desirableness of a paperless society is a common topic of discussion, there remains a great need by users of information terminals (such as personal computers, notebook computers, workstation computers, other types of computers, kiosks, PDAs, other information appliances, etc.) for printing and other image formation functionalities. Therefore, devices having printing or plotting functionality, such as printers, copiers, multi-function devices, etc., continue to play a significant role in information technology (IT) at home and at work. The term “image formation operations” is used hereinafter generically to include operations of any output devices having printing or plotting functionality, including multi-function devices having a copy and/or scanning functionality in addition to the printing or plotting functionality.

Web print services enable a user to request assorted types of printing and other image formation services, including printing large jobs of many pages and/or many copies, printing jobs require special processing (such as high resolution printing, color printing, printing to non-standard media, etc.). From the perspective of an enterprise, the ROI (return on investment) is greater when printing resources as well as IT tools at large are used for the benefit of the enterprise at large, rather than spread out for the use of local users. Accordingly, such services can be provided to an enterprise through a web portal by an IT or other department of the enterprise or by an external service provider.

It has been proposed that the print web portal can include additional facets above and beyond print and image formation operations. For example, users and others may wish to learn the status of submitted jobs and/or inquire regarding other matters through the web portal. Further, after a requested job is completed, the user or customer may wish to access summary (or detailed) information regarding a collection of jobs. For example, billing or accounting information may be requested.

Many of the additional functionalities proposed to be added to a print web portal are available through commercially available applications or systems. However, a problem commonly encountered when such commercially available systems or applications are integrated with the print web portal is that the multiple systems are heterogeneous (for example, utilize respective, different data and/or presentation formats). Even if integration is not a problem, the multiple formats present an obstacle to user-friendliness from the perspective of the web portal user, who must learn multiple formats in order to avail him/herself of the benefit of the additional functionalities provided by such multiple systems.

There is a need for improvements to a print web portal that enable it to provide a plethora of functionalities while shielding the heterogeneity within the web portal system from the user.

### BRIEF SUMMARY

This disclosure provides an approach for a print web portal that unifies the information and functionalities available through the print web portal, and enables a user to obtain said information and functionalities readily, without having to learn multiple application or system specific formats.

In accordance with one aspect, a web portal is configured for access to information and functionalities of a plurality of heterogeneous network-connected systems of respective different formats, in connection with printing and other operations for forming images. The plurality of network distributed systems manage respective different information from image forming operations. The web portal unifies data from the multiple, heterogeneous systems by converting them to, and presenting them in, a common format.

In another aspect, the web portal is configured to register dynamically a sequence of actions as a scenario, and apply the registered scenario of actions in one or more of the network distributed systems. Thus, actions bridging the web portal to functionalities provided by or through the network connected systems can be registered and automated.

A scenario includes a starting action for starting the scenario, a data process action for processing data from the starting action to a specific common format, a finishing action for saving the processed data (of the common format) from the data process action and/or sending such data to other network services, and one or more conditions added between actions connecting the actions and/or validating the data before the next action is taken.

### BRIEF DESCRIPTION OF THE DRAWINGS

The features of the present disclosure can be more readily understood from the following detailed description with reference to the accompanying drawings wherein:

FIG. 1 shows a schematic view of an architecture of a print web portal, in accordance with an exemplary embodiment of the present disclosure;

FIG. 2 shows a schematic view of a basic system structure of a print web portal, in accordance with a first example;

FIG. 3 shows a schematic view of a system structure of a print web portal including multiple device management servers and accounting servers, in accordance with a second example;

FIG. 4 shows a schematic view of a system structure of a print web portal for a large organization, in accordance with a third example;

FIG. 5 shows a schematic view of a system structure of a print web portal, in accordance with a fourth example, in which a web interface is added to the print web portal of one of the first through third examples, to communicate with a customer web service/portal;

FIG. 6 shows a schematic view of some software components of a web portal server, according to an exemplary embodiment;

FIG. 7A shows a flow chart of a basic scenario; and

FIG. 7B shows a flow chart of an example of a complex scenario; and

FIGS. 8A through 8E show an example of a work flow of a web portal server, according to an exemplary embodiment.

### DETAILED DESCRIPTION

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

This disclosure describes a web portal that, in a preferred embodiment, includes (a) user interfaces to enable a user to access network-distributed, vendor-different systems and devices, such as one or more device management systems, accounting/financing systems, user authentication systems, directory systems, and MFPs and printers, from a web browser, (b) a database associating data and information residing on each different system/device by registering the different information from different sources into a common format, and (c) means for recording sequences of actions, and registering the sequence of actions as a scenario, wherein the registered scenario can be applied to one or more of the systems. Thus, various functionalities available through the print web portal can be composed in a unified manner, to facilitate more expeditious access to tools and information.

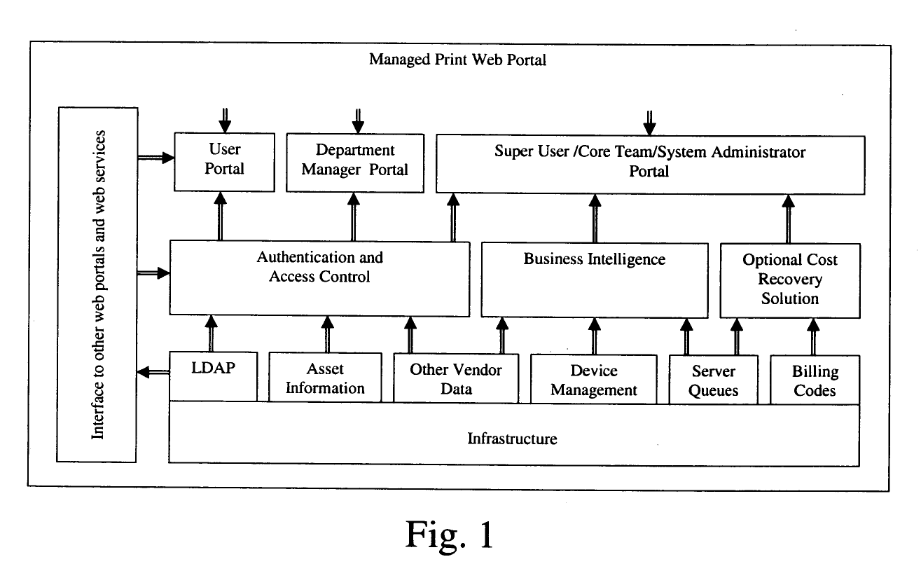

FIG. 1 shows schematically a managed print web portal architecture, in accordance with an exemplary embodiment of the present disclosure.

The print web portal includes a core infrastructure for providing network, e-mail, file store and print services. The core provides the functionalities which users most commonly invoke.

In addition, as shown in FIG. 1, a plurality of additional networked systems or components are connected to the infrastructure to provide other functionalities, including a billing/accounting database (or server), one or more server queues, a device management system (for example the @Remote appliance available from Ricoh Corporation) which gathers operations data from printers, multifunction products (MFPs), etc., a database of other vendor data, operations data and other data and generate business-relevant reports, an asset information database, and a LDAP (Lightweight Directory Access Protocol) directory server which enables a user to locate organizations, individuals, files, devices in the network and maintains data regarding access and printing rights. Such networked systems or devices can be obtained from respective different vendors/makers and/or utilizes respective different formats.

The networked components and systems enable other applications, such as a cost recovery system configured to access data from the server queues and data from the billing/accounting database, a business intelligence system configured to process server queue data, device management data and other vendor data and generate regular or ad-hoc reports and queries, and authentication and access control.

Access to the print web portal can be role-based. Thus, users can access a specific subset of the information and functionalities in the web portal system. On the other hand, department managers may access a different subset of the information and functionalities, and super users, core team members and system administrators can access an even larger subset of the information and functionalities. Accordingly, the print web portal is effectively, a user portal, a department manager portal, and another portal for super users, system administrators and the like, selected according to access control level (ACL) information, as interfaces for the user to access the assorted functionalities and information of the print web portal.

In addition, an interface to other web portals or web services (for example Lanier Direct provided by Ricoh Corporation) is provided.

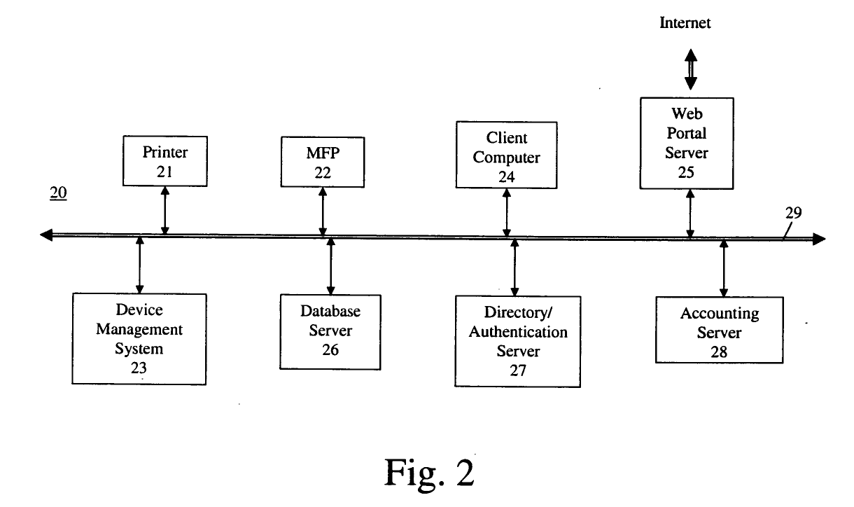

The print web portal can have any of various possible system structures. Some examples are shown in FIGS. 2-5.

FIG. 2 shows a basic system structure of a print web portal 20, in accordance with a first example. A plurality of devices (for example, a printer 21, a MFP 22, a client computer 24, etc.) and systems (for example, a device management system 23, a database server 26, a directory/authentication server 27, an accounting server 28 and a web portal server 25) are interconnected through a network 29 (for example, an intranet). The web portal server 25 functions as a gateway for access to the print web portal from the Internet, and consults with the authentication server 27 before allowing a user to access the functionalities and information in the print web portal. In the basic system structure, a single device management system 23 and a single accounting server 28 collect operations data and accounting data, respectively.

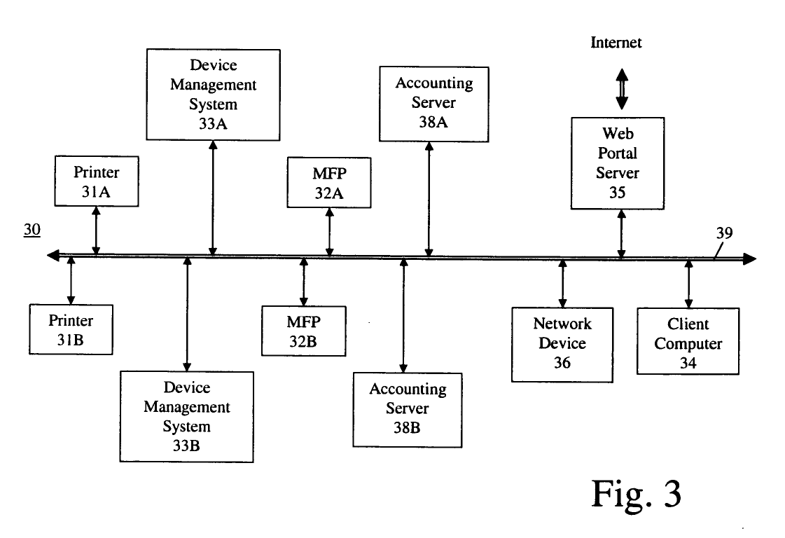

FIG. 3 illustrate a system structure of a print web portal 30, in accordance with a second example. The print web portal 30 includes multiple device management systems (33A and 33B) and multiple accounting servers (38A and 38B). In addition, each department may have one or more assigned printers (31A and 31B) and MFPs (32A and 32B). On the other hand, some network devices (34-36) may be shared. In such an example, the multiple device management systems and accounting servers may be utilized by respective departments co-located at one site and sharing a network, or for data of respective customers. However, while each department may have some IT resources assigned to be used by users in the department, a user may be permitted to access the printer or MFP of another department, with or without restriction.

In addition, device management systems and accounting servers typically have web interfaces allowing them to be accessed (assuming appropriate authorization) through the Internet. The print web portal via the web interface of the web portal server can access a device management system, accounting server or database server in the print web portal system, when said device management system, accounting server or database server is web-enabled.

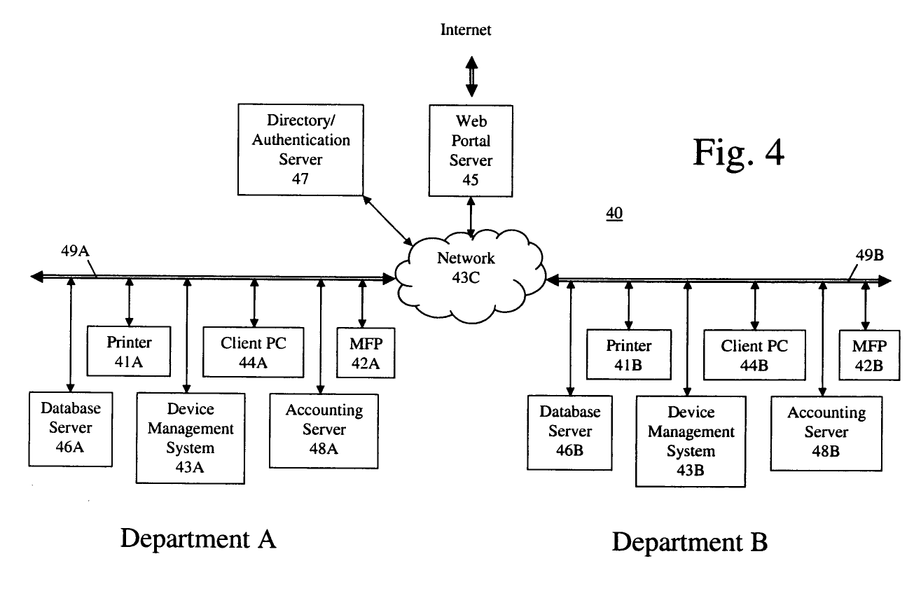

FIG. 4 shows a system structure of a print web portal for a large organization, in accordance with a third example. Such a large organization has multiple departments. Each department has its own network (49A and 49B), and a device management system (43A and 43B), accounting server (48A and 48B), database server (46A and 46B), printer (41A and 41B), MFP, client computers and other devices for use of the department are interconnected through the department network. The multiple department networks, a directory/authentication server and a web portal server are interconnected through an intranet or the Internet. Like the examples of FIGS. 2 and 3, the web portal server consults with the authentication server before allowing a user to access the functionalities and information in the print web portal. Access from one department to devices/systems on the network of another department is also authenticated before it is permitted.

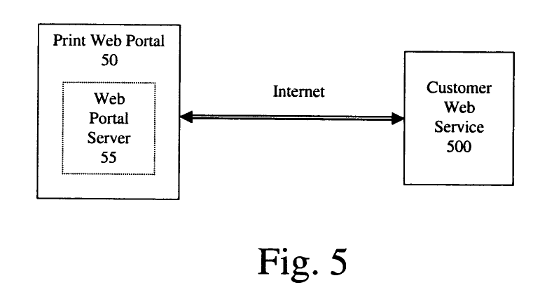

FIG. 5 shows a system structure, in accordance with a fourth example, in which web portal server 55 of print web portal 50 (for example, otherwise similar to the first through third examples) includes an interface for communicating with a customer web service/portal 500 (such as an eCommerce web site). The interface also allows the print web portal to connect to other associated eCommerce web sites and web services to provide direct order, purchase, and accounting management, and print, scan, copy, and fax service, as document-related services for the eCommerce web site.

Since network and web technologies are well understood in the art, a detailed discussion is not included herein, in the interest of clarity. Instead, reference is made to the discussion of network and web technologies in (A) How Networks Work, by Frank J. Derfler, Jr. et al., Parts 3-6, 2000 (Millenium Edition), Que Corporation, and (B) How the Internet Works, by Preston Gralla, Parts 3-9, 2000 (Millenium Edition), Que Corporation, the entire contents of each of which are incorporated by reference herein.

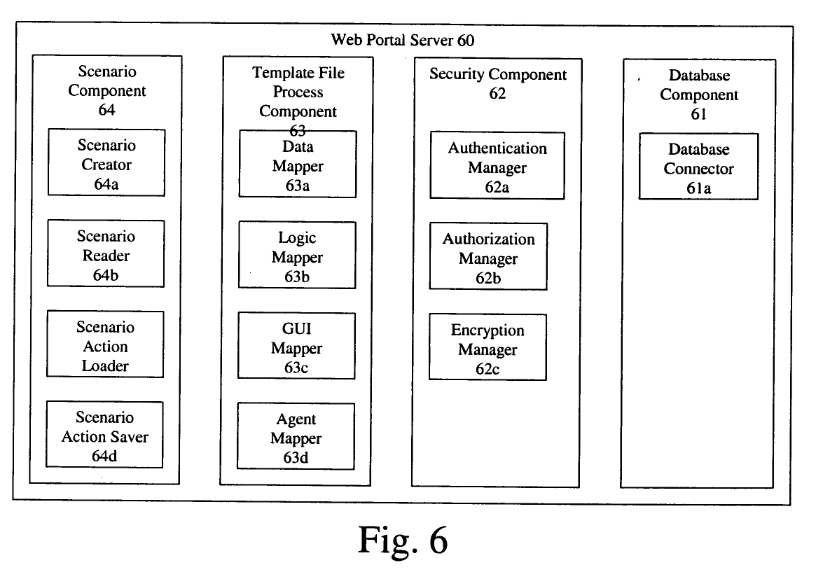

As mentioned above, the web portal server functions as a gateway between the user and the functionalities and information in the print web portal. A schematic view of some of the components of a web portal server, according to an exemplary embodiment, is shown in FIG. 6.

Web portal server 60, in the exemplary embodiment shown in FIG. 6, includes a database component 61, a security component 62, a template file process component 63 and a scenario component 64.

The database component 61 includes a database connector 61a enabling the web portal server to communication through the network with and access data in a print web portal user database or a different user database.

The security component 62 provide authentication and access control, and includes an authentication manager 62a, an authorization manager 62b, and an encryption/decryption manager 62c. The operations of the database and security components can be coupled. For example, access level information can be added to registered data/information, and the security component decides whether to permit or deny access to a specific user, based on user access level or authentication information. User access level can be checked according to registered user information in the web portal user database or different user database.

The authentication manager 62a utilizes identification information received from the user, and consults with the authentication server to authenticate the user. The authorization manager 62b determines, based on access level definitions for specified functionality and/or data, whether an authenticated user is to be permitted to have access to the functionality and/or data. The encryption/decryption manager 62c oversees encryption of data to be transmitted and decryption of encrypted data received by the print web portal.

The template file process component 63 includes a data mapper 63a, a logic mapper 63b, a GUI mapper 63c and an agent mapper 63d. The data mapper 63a utilizes data mapping (template) files, along with in-coming data received by the web portal, and converts the data to a common format or target format. The logic mapper 63b utilizes logic mapping files, and converts in-coming commands to a target service command. The GUI mapper 63 utilizes GUI mapping (template) files, and generates appropriate user interface pages. The agent mapper 63d, utilizing the in-coming data and commands, generates and/or activates appropriate agents, as the circumstances require.

The print web portal preferably utilizes a plurality of software agents, which are transparent to the user, to assist in interconnection of functionalities and retrieval of information. The implementation of software agents is generally well understood in the art and therefore a detailed discussion of software agents is omitted in the interest of clarity regarding the subject matter claimed to be novel and unobvious. However, exemplary discussions of software agents can be found in (I) Zakaria Maamar et al., “An Agent=based Approach to Specify a Web Service-oriented Environment,” Proc. 12^{th} IEEE Int'l Workshop on Enabling Technologies: Infrastructure for Collaborative Enterprises (2003), (II) Nicholas Gibbins et al., “Agent-based Semantic Web Services,” (31 Oct. 2003, Elsevier Science), and (III) Dominic Greenwood et al., “Engineering Web Service—Agent Integration,”2004 IEEE, the entire contents of each of which are incorporated herein by reference.

Agents can be registered in the print web portal system statically (that is, does not go away) or dynamically (for example, upon user action). In-coming data and commands received by the print web portal can be reformatted to be usable for one or more services provided by the systems, devices or applications, with assistance of agents. In addition, agents can be utilized to read, store and/or otherwise access data in (for example, query) the databases in the print web portal system. Agents collect data from the services and the data can be reformatted for presentation to the user through an appropriate user interface. Agents can also be utilized to create web interfaces for accessing or communicating with other web services or portals. Thus, a user, another agent or a service can add, read write and delete data in the print web portal.

In addition, the print web portal, through one or more agents, can gather device information and data, in different formats, from different device management systems, reformat the collected information and data into one common format, and register the information and data from the different sources into one database. For example, the print web portal gathers accounting/financial information and data in different formats from different accounting/financing systems, reformats the information and data into one common format, and registers the reformatted information and data of the different accounting/financing systems into one database.

Agents also assist the print web portal in other tasks, such as accessing a network devices directory, registering information/data into database management systems on the network, accessing network devices (for example, through other agents on the devices), and configuring and monitoring network devices and registering the devices with the device management system or incorporating with web service on the device.

Returning to FIG. 6, the scenario component 64 includes a scenario creator 64a, scenario reader 64b, scenario action loader 64c and scenario action saver 64d, for creating, reading, loading and saving, respectively, a scenario. The print web portal can save routine tasks as one scenario file, for example, an XML file. Scenarios can be used as the basic construct for a software agent.

A scenario includes the following items: input; process; output; and condition. Input is the starting action of the scenario, and an agent can be assigned for starting the scenario. Process is the data process action of the scenario, and it receives data from the input and processes the data to a specific format. Output is the finishing action of the scenario, and it receives processed data from the process action and saves the data to portal repository or sends it to other network services. Condition can be added between actions to connect the actions. For example, data can be validated before the next action is taken. Single scenario can be concatenated. For example, one scenario can be setup for next scenario.

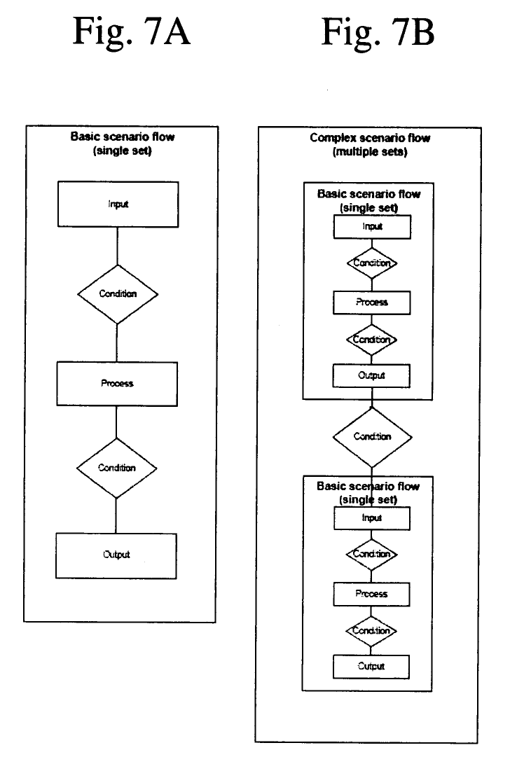

A basic scenario flow is shown in FIG. 7A. A flow of an example of a complex scenario wherein a condition connects two basic scenarios is shown in FIG. 7B.

An agent can include all four items, and an agent can be set as one item. Accordingly, the four items in a basic scenario (that is, input, process, output and condition) may be assigned respective agents.

A sample scenario XML file is provided below.

```
<SCENARIO Name=“step1”>
  <INPUT>
    <Agent name=“Agent1”>
      <URL>http://url/inputapplication</URL>
      <CONDITION type=“before”>null</CONDITION>
      <CONDITION type=“after”>null</CONDITION>
      <COMMAND webapi=“http://url/inputapplication/
      submita”>Submit A</COMMAND>
    </Agent>
  </INPUT>
  <EDIT>
    <Agent name=“Agent2”>
      <URL>http://url/editapplication</URL>
      <CONDITION type=“before”>null</CONDITION>
      <CONDITION type=“after”>null</CONDITION>
      <COMMAND webapi=“http://url/editapplication/
      submitb”>Submit B</COMMAND>
    </Agent>
  </EDIT>
  <OUTPUT>
    <Agent name=“Agent2”>
      <URL>http://url/outputapplication</URL>
      <CONDITION type=“before”>null</CONDITION>
      <CONDITION type=“after”>null</CONDITION>
      <COMMAND webapi=“http://url/outputapplication/
      save”>Save</COMMAND>
    </Agent>
  </OUTPUT>
<VIEW>
        <Buttoon name=“submit”></Button>
</VIEW>
<DATA>
  <INPUT2EDIT>
  <MAP1>
      <INPUT_vall type=“string”></INPUT_vall>
      <EDIT_vall type=“string”></EDIT_vall>
    </MAP1>
  </INPUT2EDIT>
  <EDIT2OUTPUT>
  </EDIT2OUTPUT>
  <INPUT2OUTPUT>
  </INPUT2OUTPUT>
</DATA>
</SCENARIO>
```

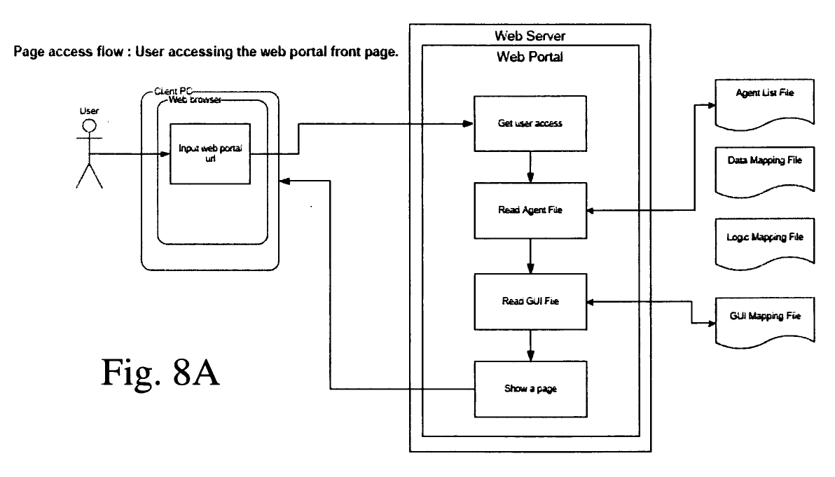

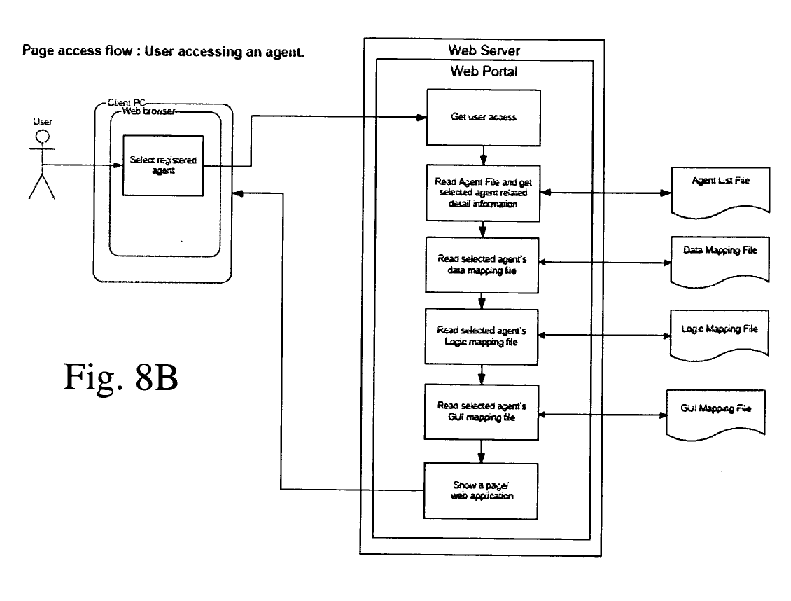

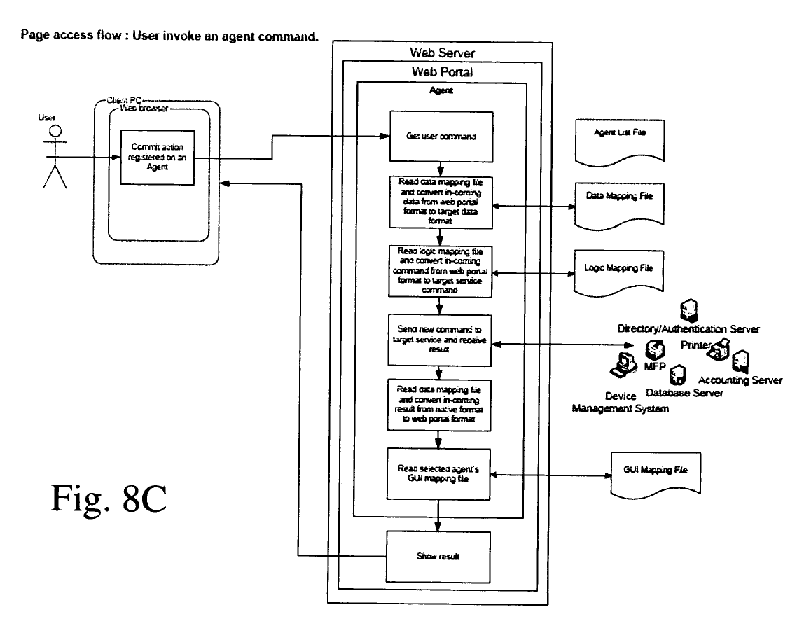

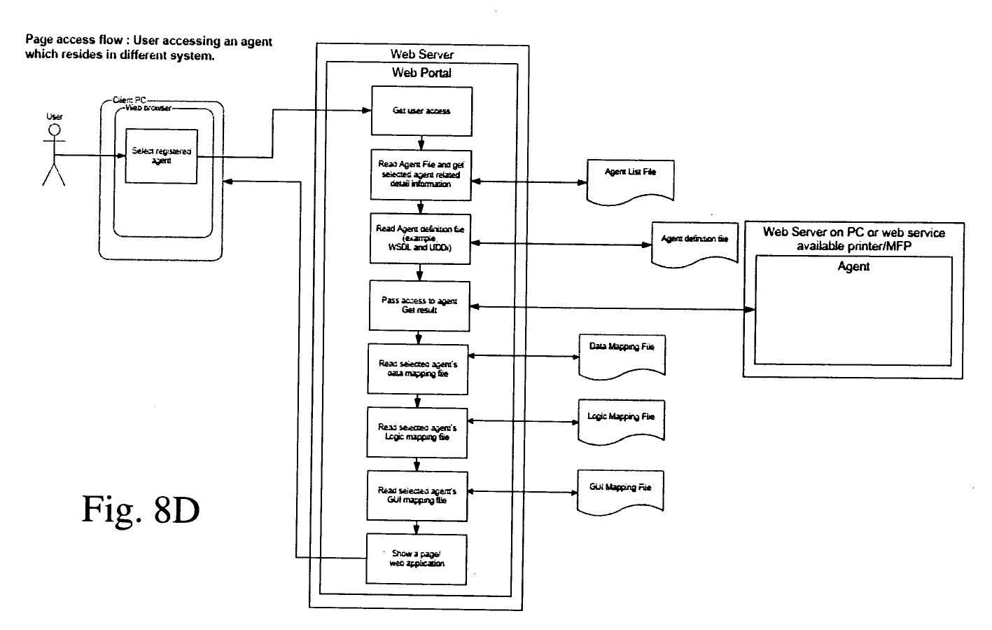

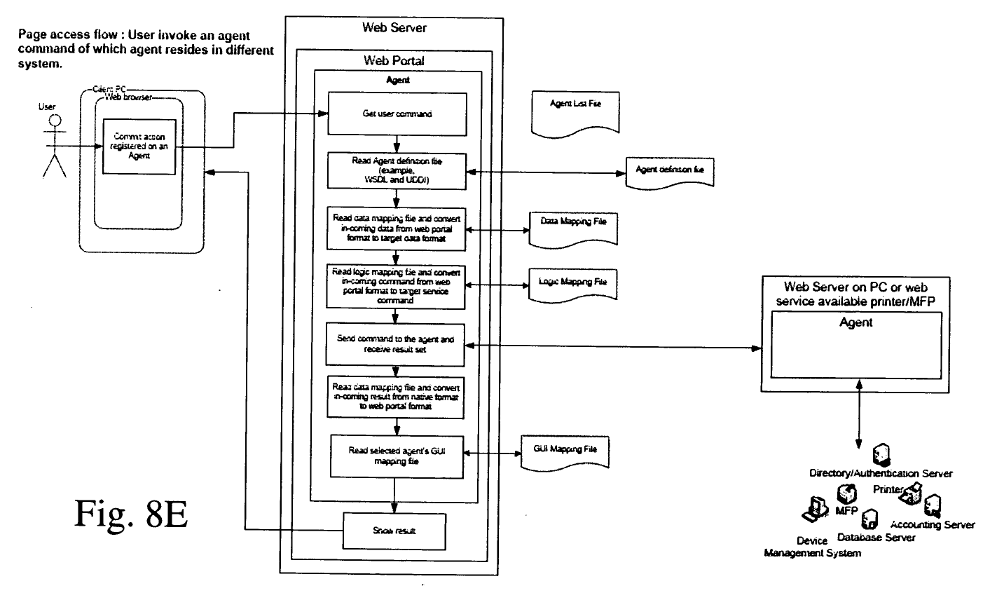

An exemplary work flow of the web portal server will be discussed below with reference to FIGS. 8A through 8E.

A user accesses the web portal home page using a web browser on a client PC (FIG. 8A). The user enters the URL (Uniform Resource Locator) of the print web portal via the browser, and the client PC makes a request for connection to the print web portal (via TCP/IP). In response to the request, the web portal server initiates a user access process, which may involve authentication (not shown in FIG. 7). However, assuming any authentication requirements are satisfied, the web portal server proceeds to use a static agent to retrieve an agent list file. In addition, the web portal server reads a GUI mapping file specific to user access. The GUI mapping in combination with the agent list file are utilized to generate a page to be shown on the web browser on the client PC and containing the agents that can be selected.

The user can select one of the agents shown on the page, and a process for handling user access to the selected agent (FIG. 8B) is thereby triggered. In response to the user selection of an agent, the web portal server retrieves the user access information (including information identifying the selected agent). The agent file corresponding to the selected agent is read, and the detail information related to the selected agent is retrieved. Using the detail information, the data mapping file of the selected agent is read, the logic mapping file of the selected agent is read, and the GUI mapping file of the selected agent is read. The data mapping file, logic mapping file and GUI mapping file are utilized in combination to generate a page and/or web application which is transmitted to the client PC and displayed through the browser on the client PC. The displayed page allows the user to specify or select an action (which can be associated with an agent command).

When the user selects an action (which invokes an agent command), the web portal server proceeds to perform a process for executing the invoked command (FIG. 8C). The web portal server retrieves the user command and in-coming data, and with the benefit of the appropriate agent, reads a corresponding data mapping file and accordingly converts the in-coming data from web portal format to the target data format which is common to all data in the print web portal system. In addition, the server reads a logic mapping file and converts the invoked command from web portal format to target service command. Next, the converted command is sent to the target service (for example, directory/authentication server, printer, MFP, accounting server, database server, device management system, etc.), and the returned result is thereafter received from the service. The server reads another data mapping file and accordingly converts the in-coming result from the native format of the service to web portal format. Next, the server reads the GUI mapping file of the invoked agent, and the result is accordingly mapped and then transmitted to the client PC.

The user can also access an agent on a different system, and in such an instance the web portal server performs a different process (FIG. 8D). In response to the user access, the web portal server reads the corresponding agent file and retrieves selected agent-related detail information. In addition, the web portal server reads the agent definition file, such as in WSDL (Web Services Description Language), UDDI (Universal Description Discovery and Integration), etc. Next, the web portal server passes the access to the agent (on, for example, printer, MFP, PC, etc.), and then receives the result from the agent. Thereafter, the web portal server reads an appropriate data mapping file, an appropriate data mapping file, and a GUI mapping file, and then generates a page or web application accordingly, and transmits to the client PC.

In addition, the user can invoke an agent command with the agent residing on another system (FIG. 8E). The web portal server retrieves the user command and reads the agent definition file. In addition, the web portal server reads a corresponding data mapping file and accordingly converts the in-coming data from web portal format to the target data format, and reads a logic mapping file and converts the in-coming command from web portal format to target service command. Next, the converted command is sent to the agent (residing on a printer, MFP, PC, etc.), which in turn performs its action(s) on a target service (for example, directory/authentication server, printer, MFP, accounting server, database server, device management system, etc.), and the result set returned by the agent is thereafter received. The server reads another data mapping file and accordingly converts the in-coming result from the native format of the service to web portal format. Next, the server reads the GUI mapping file of the agent, and the result is accordingly mapped and then transmitted to the client PC.

The print web portal also preferably can register document forms (for example, using XML, HTML, etc.), such as invoices, service requests, purchase orders, etc., provide means for generating reports and forms according to user defined format from the centric database, and transfer the reports and forms to other internal systems or external web portals. In addition, the print web portal may request outsourcing, if and when necessary, of asset management, printing, and accounting services, as well as print output consultation services.

The above specific embodiments are illustrative, and many variations can be introduced on these embodiments without departing from the spirit of the disclosure or from the scope of the appended claims. For example, elements and/or features of different examples and illustrative embodiments may be combined with each other and/or substituted for each other within the scope of this disclosure and appended claims.

What is claimed is:

1. A web portal for accessing information and functionalities of a plurality of heterogeneous systems connected through a network, in connection with printing and other operations for forming images, comprising:
a user interface configured to enable a user to access a plurality of network distributed systems of respective different formats, said plurality of network distributed systems managing respective different information from image forming operations;
a database storing association information associating, for each of said network distributed systems, data residing in the network distributed system with a common format; and
a scenario registration part configured to register dynamically a sequence of actions as a scenario, and apply said registered scenario of actions in one or more of said network distributed systems.

2. The web portal of claim 1, wherein said plurality of network distributed systems include a device management system, an accounting system, a user authentication system, a directory system, and a plurality of image forming devices.

3. The web portal of claim 1 further comprising an agent configured to discover a native format of any selected one of said network distributed systems, read target data from said one of said network distributed system in said native format, and store incoming data to said one of said network distributed system in said native format.

4. The web portal of claim 3, wherein said agent reformats said target data read from said one of said network distributed system in said native format, to said common format of said web portal.

5. The web portal of claim 1 further comprising an agent configured to, when needed, discover a native format of any specified one of said network distributed systems, and create a web interface for accessing the specified network distributed system.

6. The web portal of claim 5, wherein access level information is registered along with said association information in said database, and said web interfaces permits or disables user access based on said access level information and authentication information.

7. The web portal of claim 1 further comprising an agent configured to discover a native format of a network distributed device management system, gather device data in said native format from said network distributed device management system, reformat the gathered device data in said common format, and registered the reformatted device data in said database.

8. The web portal of claim 1 further comprising an agent configured to discover a native format of an accounting system, gather accounting data in said native format from said network distributed device management system, reformat the gathered accounting data in said common format, and registered the reformatted accounting data in said database.

9. The web portal of claim 1 further comprising an agent configured to discover a native format of a network device, and access a network device directory.

10. The web portal of claim 1 further comprising an agent configured to discover a native format of a network device, access said network device, and configure and monitor said network device.

11. The web portal of claim 1, wherein said user interface enables the user to specify a format of a new form or report, said format of said new form or report is registered in said database, and said new form or report is generated, as needed, based said registered format information in said database.

12. The web portal of claim 1, wherein said new form or report is transmitted to a specified destination on said network.

13. The web portal of claim 1, wherein said scenario consists of (i) an input corresponding to a starting action, (ii) a process corresponding to a data process action which receives data from said input and processes the data to a specific format, (iii) an output corresponding to a finishing action, and (iv) one or more conditions in between said input and process and between said process and said output.

14. The web portal of claim 13, wherein each of said input, process, output and condition of said scenario is performed by a single agent.

15. The web portal of claim 13, wherein said input, process, output and condition of said scenario are performed by respective agents.

16. The web portal of claim 1 further comprising an agent configured to connect with a web service through said network.

17. The web portal of claim 1 further comprising:
wherein said user interface configured to receive incoming data and a user command for accessing a specified one of said plurality of network-distributed systems, and
said web portal further comprises:
a data mapping agent configured to discover a native format of said specified one of said plurality of network-distributed systems, and reformat said incoming data to said native format of said specified one of said plurality of network-distributed systems;
a logic mapping agent configured to convert said user command to a target service command specific to said specified one of the plurality of network-distributed systems; and
a back end interface configured to send the reformatted data and the target service command to said specified one of the plurality of network-distributed systems, and convert results data from said specified one of the plurality of network-distributed systems from said native format to said common format.

18. The web portal of claim 1, wherein said plurality of network-distributed systems are supplied by respective different vendors, and have respective different native formats.

19. The web portal of claim 1, wherein said web portal is accessed via the web by the user through a web browser.

20. The web portal of claim 1, wherein said plurality of network-distributed systems are respective components of an IT system of an enterprise, and are used by respective departments of said enterprise.
